(19) United States
(12) Patent Application Publication
(10) Pub. No.: US 2026/0112871 A1
(43) Pub. Date: Apr. 23, 2026

(54) PROTECTOR

(71) Applicant: SUMITOMO WIRING SYSTEMS, LTD., Mie (JP)

(72) Inventors: Yuji OKAMOTO, Mie (JP); Masao SUZUKI, Mie (JP); Hideki HATTORI, Mie (JP); Atsushi ONO, Mie (JP); Toru KAWAMIYA, Mie (JP); Toshiaki UENO, Mie (JP); Shota MORIKAWA, Mie (JP)

(21) Appl. No.: 19/360,381

(22) Filed: Oct. 16, 2025

(30) Foreign Application Priority Data
Oct. 17, 2024 (JP) 2024-181821

(51) Int. Cl. H02G 3/04; H02G 3/30

(52) U.S. Cl. CPC H02G 3/04; H02G 3/30

(57) ABSTRACT

A protector includes a protector body including a fixing portion fixed to a side wall of a mounting member along a first direction intersecting the side wall and configured to hold a wire group, a connector provided further toward an upper side than the fixing portion, a mating connector being connected to the connector from the first direction, and a resilient piece provided to extend toward a lower side and extend in a first opposite direction opposite to the first direction from below the fixing portion and able to be pressed into contact with a bottom wall of the mounting member to suppress inclination of the protector body with the fixing portion as a base point with the connector biased in the first opposite direction by the mating connector.

### CROSS-REFERENCE TO RELATED APPLICATIONS

This application is based on and claims priority from Japanese Patent Application No. 2024-181821, filed on Oct. 17, 2024, with the Japan Patent Office, the disclosure of which is incorporated herein in its entirety by reference.

### TECHNICAL FIELD

The present invention relates to a protector.

### BACKGROUND

Conventionally, a known protector for holding and protecting a wire group includes a fixing portion to be fixed by being relatively moved along a direction intersecting a side wall of a mounting member with respect to the side wall (see, for example, Japanese Patent Laid-open Publication No. H07-143647). The fixing portion is, for example, configured to be fittable into a fixing hole formed in the side wall, and facilitates the fixing of the protector.

### SUMMARY

Some protectors are, for example, integrally provided with a connector. In such a case, the protector may be biased by a mating connector to be connected to the connector. Then, the protector may remain inclined with the fixing portion as a base point.

The present disclosure aims to provide a protector capable of suppressing inclination with a fixing portion as a base point.

The present disclosure is directed to a protector with a protector body including a fixing portion to be fixed to a side wall of a mounting member along a first direction intersecting the side wall, the protector body holding a wire group, a connector provided above the fixing portion, a mating connector being connected to the connector from the first direction, and a resilient piece provided to extend downward and extend in a first opposite direction opposite to the first direction from below the fixing portion, the resilient piece being able to be pressed into contact with a bottom wall of the mounting member to suppress inclination of the protector body with the fixing portion as a base point with the connector biased in the first opposite direction by the mating connector.

According to the protector of the present disclosure, inclination with the fixing portion as a base point can be suppressed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a wiring harness and a mounting member in one embodiment.

FIG. 2 is a perspective view of the wiring harness in the embodiment.

FIG. 3 is a perspective view of a protector and wire groups in the embodiment.

FIG. 4 is a front view of the protector and the wire groups in the embodiment.

FIG. 5 is a transverse section of the wiring harness and the mounting member in the embodiment.

FIG. 6 is a transverse section of the wiring harness and the mounting member in the embodiment.

FIG. 7 is a transverse section of a wiring harness and a mounting member in another example.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.
[1] The protector of the present disclosure is provided with a protector body including a fixing portion to be fixed to a side wall of a mounting member along a first direction intersecting the side wall, the protector body holding a wire group, a connector provided above the fixing portion, a mating connector being connected to the connector from the first direction, and a resilient piece provided to extend downward and extend in a first opposite direction opposite to the first direction from below the fixing portion, the resilient piece being able to be pressed into contact with a bottom wall of the mounting member to suppress inclination of the protector body with the fixing portion as a base point with the connector biased in the first opposite direction by the mating connector.

According to this configuration, since the resilient piece provided to extend downward and extend in the first opposite direction from below the fixing portion is pressed into contact with the bottom wall of the mounting member even if an upper part of the protector above the fixing portion is biased in the first opposite direction, the inclination with the fixing portion as a base point is suppressed. Further, since the resilient piece is provided to extend downward and extend in the first opposite direction, the resilient piece is satisfactorily pressed into contact with the bottom wall even if a distance from the fixing portion to the bottom wall is subtly different, for example, due to a manufacturing error of the mounting member or the like. Therefore, the inclination of the protector with the fixing portion as a base point is stably suppressed.
[2] In [1] described above, a length of the resilient piece may be so set that the resilient piece projects further in the first opposite direction than the protector body while being pressed in contact with the bottom wall.

According to this configuration, since the length of the resilient piece is so set that the resilient piece projects further in the first opposite direction than the protector body while being pressed in contact with the bottom wall, the resilient piece is satisfactorily pressed into contact with the bottom wall even if the distance from the fixing portion to the bottom wall is subtly different, for example, due to the manufacturing error of the mounting member or the like. Therefore, the inclination of the protector with the fixing portion as a base point is stably suppressed.
[3] In [1] or [2] described above, two connectors may be provided, and one resilient piece may be provided below and between the two connectors.

According to this configuration, since one resilient piece is provided below and between the two connectors biased by mating connectors, the inclination of the protector with the fixing portion as a base point can be suppressed in a well-balanced manner by one resilient piece.
[4] In [3] described above, a downward extending portion extending downward may be provided on a lower side of the protector body between the two connectors, and the resilient piece may be provided to extend downward and extend in the first opposite direction from a lower end of the downward extending portion.

According to this configuration, since the resilient piece is provided to extend downward and extend in the first opposite direction from the lower end of the downward extending portion, a position where the resilient piece is pressed into contact with the bottom wall can be set far from the fixing portion. Therefore, the inclination of the protector with the fixing portion as a base point is more suppressed.
[5] In [4] described above, the protector body may include a body portion provided with an opening open in the first opposite direction and configured to accommodate the wire group inside and a cover portion coupled to a lower end of the body portion rotatably from an open state to a closed state by a thin hinge portion at a position corresponding to the connector and configured to close the opening in the closed state, the downward extending portion may include a downward extending inclined portion widening the downward extending portion toward an upper side when viewed in the first direction, and the cover portion in the open state may include a cover inclined portion widening the cover portion toward a lower side by being inclined along the downward extending inclined portion while forming a gap between the downward extending inclined portion and the cover inclined portion when viewed in the first direction.

According to this configuration, since the protector body includes the body portion provided with the opening open in the first opposite direction and configured to accommodate the wire group inside and the cover portion configured to close the opening, the protrusion of the wire group from the protector body is prevented. Further, since the cover portion is coupled to the lower end of the body portion rotatably from the open state to the closed state by the thin hinge portion at the position corresponding to the connector, the cover portion can be integrally molded to the body portion. Further, since the downward extending portion includes the downward extending inclined portion widening the downward extending portion toward the upper side when viewed in the first direction, the downward extending portion can be suppressed from being bent even if the resilient piece is pressed into contact with the bottom wall. Thus, the inclination of the protector with the fixing portion as a base point can be stably suppressed. Further, the cover portion in the open state includes the cover inclined portion widening the cover portion toward the lower side by being inclined along the downward extending inclined portion while forming the gap between the downward extending inclined portion and the cover inclined portion when viewed in the first direction. Thus, a range where the cover portion covers the opening can be widened while the integral molding of the cover portion and the downward extending portion is facilitated.
[6] In [4] or [5] described above, the downward extending portion may include a different type wire holding portion capable of holding a different type wire group.

According to this configuration, the different type wire group can be held by the different type wire holding portion of the downward extending portion.
[7] In [6] described above, the downward extending portion may include the different type wire holding portion provided to extend downward from the protector body, a pair of both side downward extending portions extending downward from the protector body on both sides of the different type wire holding portion while being separated from the different type wire holding portion, and a coupling portion coupling tips of the pair of both side downward extending portions, and the resilient piece may be provided to extend downward and extend in the first opposite direction from a lower end of the coupling portion.

According to this configuration, the coupling portion and the pair of both side downward extending portions where the resilient piece is provided are configured to hardly receive a force from the different type wire holding portion by being separated from the different type wire holding portion. Therefore, even if a force is applied to the different type wire holding portion from the different type wire group, it is suppressed that functions of the resilient piece are impaired.
[8] In [1] described above, a length of the resilient piece may be so set that the resilient piece does not project in the first opposite direction from the protector body while being pressed in contact with the bottom wall.

According to this configuration, since the length of the resilient piece is so set that the resilient piece does not project in the first opposite direction from the protector body while being pressed in contact with the bottom wall, the enlargement of an arrangement space for the protector when viewed from above can be, for example, prevented.

### Details of Embodiment of Present Disclosure

A specific example of a wiring harness of the present disclosure is described below with reference to the drawings. For the convenience of description, some components may be shown in an exaggerated or simplified manner in each drawing. Further, a dimension ratio of each part may be different in each drawing.

Terms such as “first”, “second” and “third” used in the description of this specification are merely used to distinguish objects and do not rank the objects. The present invention is not limited to these illustrations, but is represented by claims and intended to include all changes in the scope of claims and in the meaning and scope of equivalents.

### Configuration of Wiring Harness 10

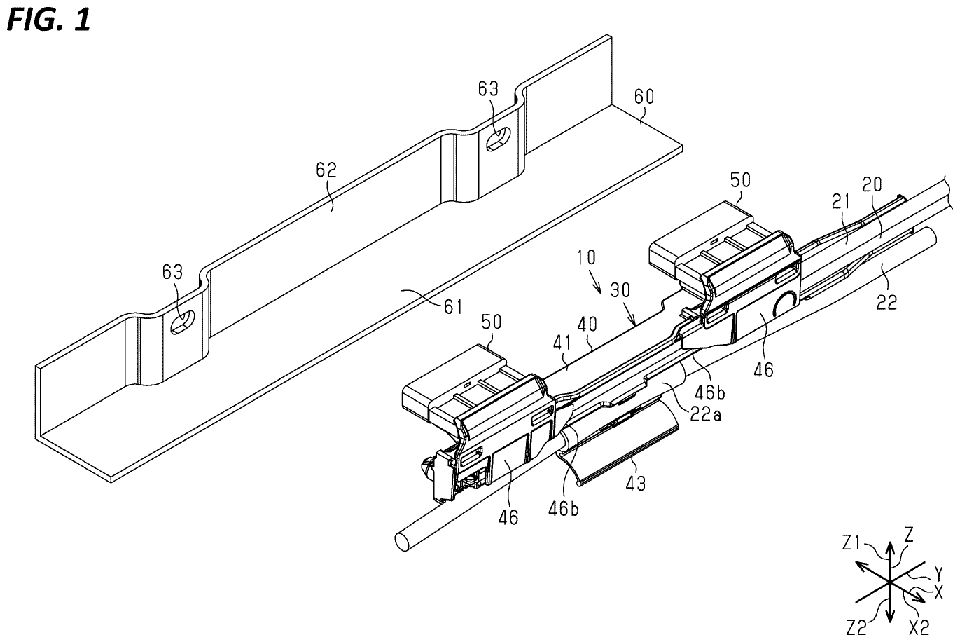

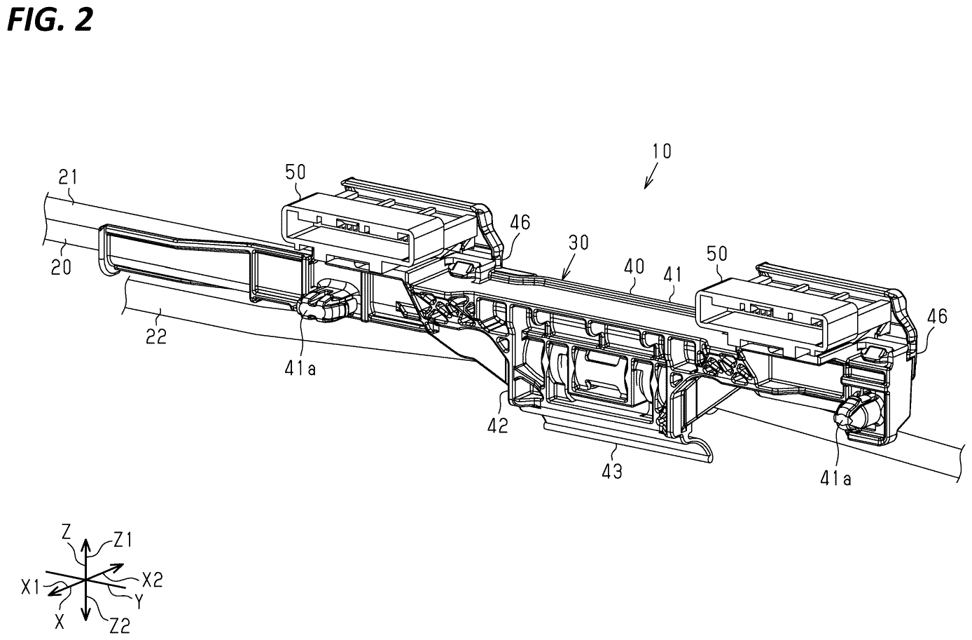

As shown in FIGS. 1 and 2, a wiring harness 10 is provided with two wire groups 20, 21, one different type wire group 22 and a protector 30. Further, the protector 30 is provided with a protector constituent member 40 and two connectors 50. The wiring harness 10 of this embodiment is, for example, fixed to a mounting member 60 constituting a part of an enclosure of a battery pack mounted in an unillustrated vehicle such as a hybrid vehicle or an electric vehicle.

In each figure, a first axis X, a second axis Y orthogonal to the first axis X and a third axis Z orthogonal to the first and second axes X, Y are shown. Further, a first direction X1, which is one direction along the first axis X, and a first opposite direction X2, which is a direction opposite to the first direction X1, are shown in figures. Further, a direction toward an upper side Z1, which is one direction along the third axis Z, and a direction toward a lower side Z2, which is a direction opposite to the direction toward the upper side Z1, are shown in figures.

### Configuration of Mounting Member 60

As shown in FIG. 1, the mounting member 60 includes a plate-like bottom wall 61 orthogonal to the third axis Z and a plate-like side wall 62 extending toward the upper side Z1 from the bottom wall 61 and orthogonal to the first axis X. The side wall 62 is formed into an elongated shape along the second axis Y and includes two fixing holes 63 at positions separated along the second axis Y.

### Configuration of Protector Constituent Member 40

As shown in FIGS. 2 to 5, the protector constituent member 40 includes a protector body 41, a downward extending portion 42 and a resilient piece 43. The protector body 41, the downward extending portion 42 and the resilient piece 43 constitutes an integrally molded product. The protector body 41 is formed into an elongate shape along the second axis Y to hold the elongated wire groups 20, 21 inside.

### Configuration of Connectors 50

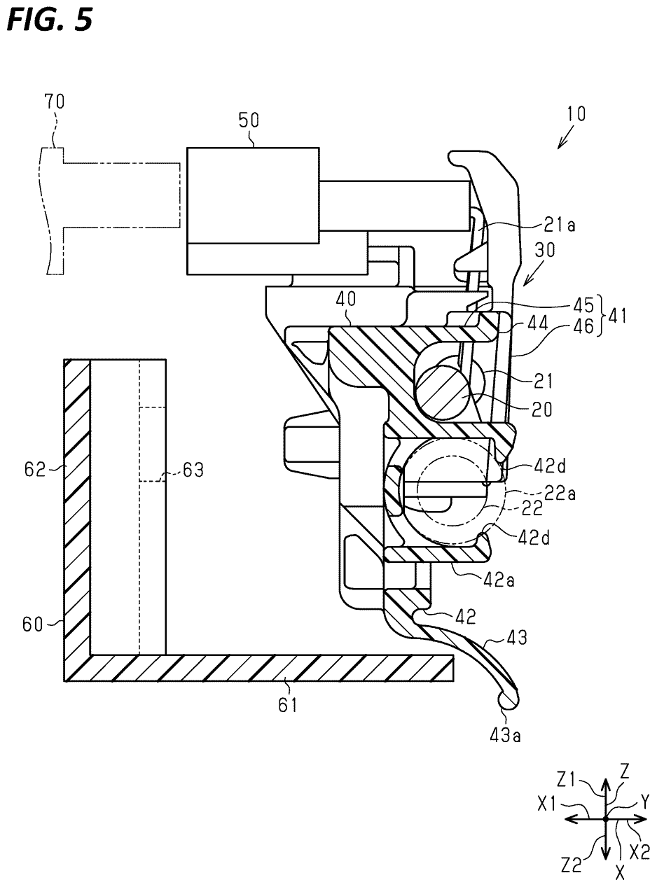

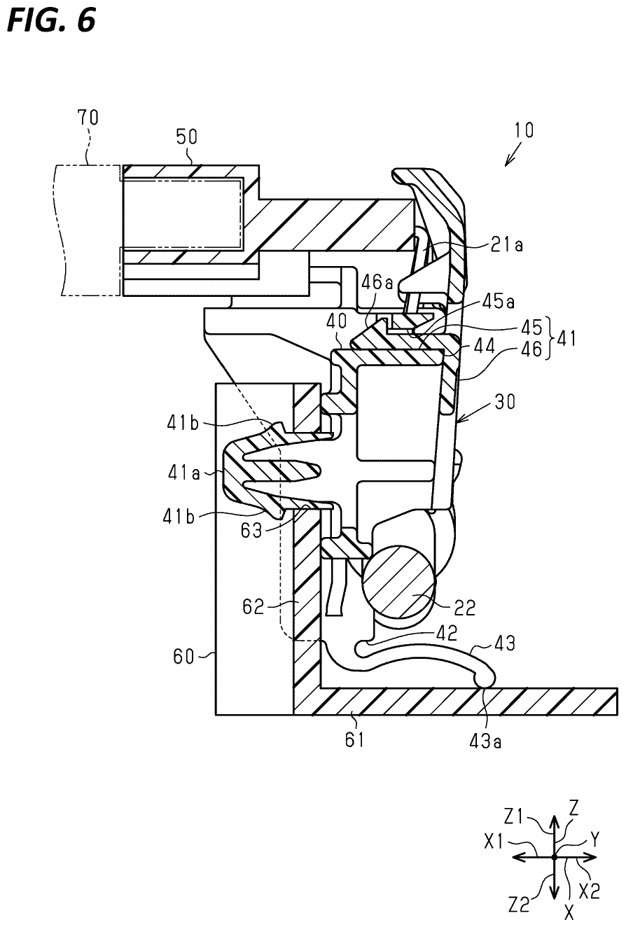

As shown in FIGS. 1 to 4, the connectors 50 are provided on the upper side Z1 of the protector body 41. Two connectors 50 are fixed at positions separated along the second axis Y on the upper side Z1 of the protector body 41. The connector 50 is so formed that a mating connector 70 (see FIGS. 5 and 6) is connected thereto from the first direction X1.

### Configuration of Protector Body 41

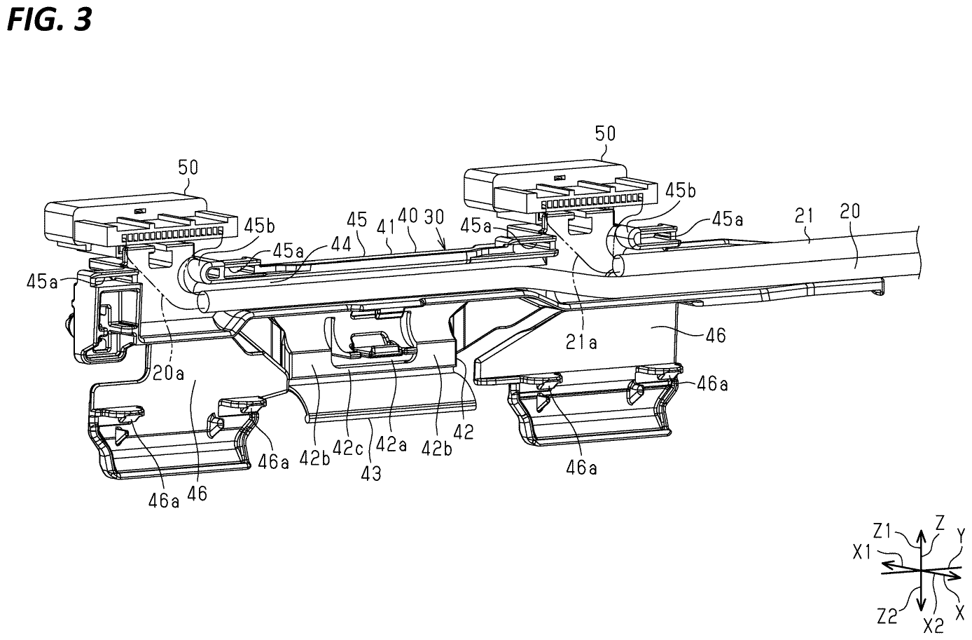

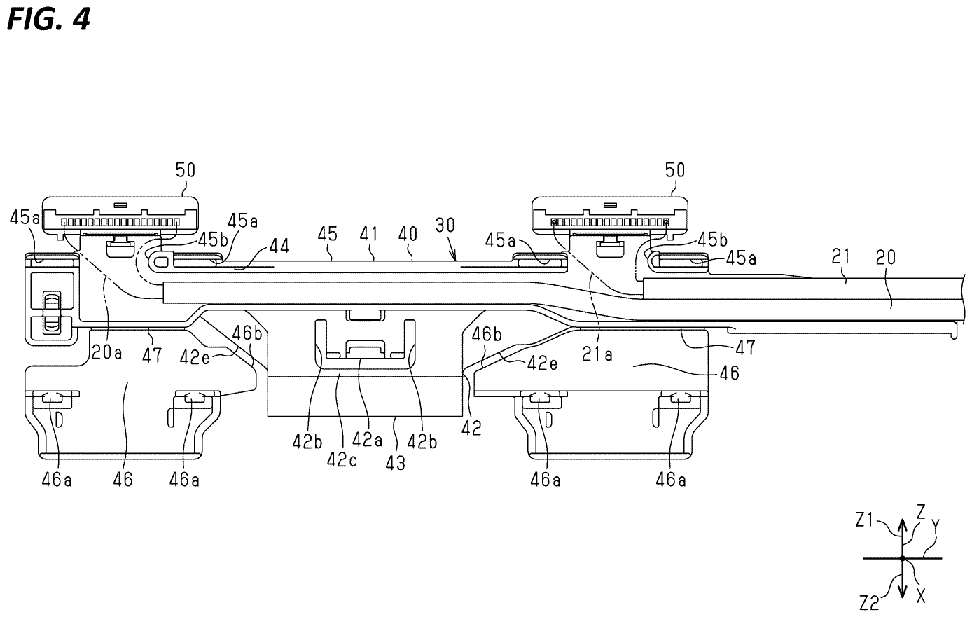

As shown in FIGS. 3 to 5, the protector body 41 includes a body portion 45 provided with an opening 44 open in the first opposite direction X1 and configured to accommodate the wire groups 20, 21 inside, and cover portions 46 for closing the opening 44. The cover portions 46 of this embodiment are coupled to the lower end of the body portion 45 rotatably from an open state to a closed state by thin hinge portions 47 (see FIG. 4) at two positions corresponding to the connectors 50 and close the opening 44 in the closed state. As shown in FIG. 6, the cover portion 46 includes an engaging claw 46a to be locked into an engaging hole 45a provided in the body portion 45 in the closed state. Note that the cover portions 46 in the closed state are shown in FIGS. 1, 2, 5 and 6 and the cover portions 46 in the open state are shown in FIGS. 3 and 4.

Further, the body portion 45 includes communicating portions 45b (see FIGS. 3 and 4) open to the upper side Z1 at two positions corresponding to the connectors 50. A plurality of wires 20a, 21a constituting the wire groups 20, 21 are connected to end parts in the first opposite direction X2 of the connectors 50 through the communicating portions 45b from the inside of the protector body 41. Note that the wire groups 20, 21 are, for example, bundled by taping or the like, and loosened in parts passing through the communicating portions 45b. The plurality of wires 20a, 21a are connected to the end parts in the first opposite direction X2 of the connectors 50 while being arranged along the second axis Y. Note that the plurality of wires 20a, 21a are schematically shown by two-dot chain lines in FIGS. 3 and 4. In particular, in FIGS. 3 and 4, only the outermost ones of the plurality of wires 20a, 21a are shown and ranges where the plurality of wires 20a, 21a pass are shown by two-dot chain lines.

Further, as shown in FIGS. 2 and 6, the protector body 41 includes fixing portions 41a to be fixed to the side wall 62 of the mounting member 60 (see FIG. 1) along the first direction X1 intersecting the side wall 62. The fixing portions 41a are provided further toward the lower side Z2 than the connectors 50. The fixing portions 41a are provided at two positions corresponding to the connectors 50 and corresponding to the fixing holes 63 of the side wall 62. As shown in FIG. 6, the fixing portion 41a includes a pair of fixing pieces 41b projecting in the first direction X1 and spreading outward away from each other in the first opposite direction X2. If the fixing portion 41a is inserted into the fixing hole 63 along the first direction X1, the fixing pieces 41b are engaged with an edge part of the fixing hole 63, whereby the fixing portion 41a can be fixed to the fixing hole 63.

### Configuration of Downward Extending Portion 42

As shown in FIG. 4, the downward extending portion 42 is provided on a lower side Z2 of the protector body 41 between the two connectors 50. The downward extending portion 42 extends toward the lower side Z2 of the protector body 41. The downward extending portion 42 includes a different type wire holding portion 42a capable of holding a different type wire group 22 (see FIGS. 1 and 5). In particular, the downward extending portion 42 includes the different type wire holding portion 42a, a pair of both side downward extending portions 42b and a coupling portion 42c. The different type wire holding portion 42a is provided to extend toward the lower side Z2 from the protector body 41. The pair of both side downward extending portions 42b are provided to extend toward the lower side Z2 from the protector body 41 on both sides of the different type wire holding portion 42a while being separated from the different type wire holding portion 42a. The coupling portion 42c couples the tips of the pair of both side downward extending portions 42b.

As shown in FIG. 5, the different type wire holding portion 42a includes a pair of holding claws 42d capable of holding the different type wire group 22. The different type wire group 22 is held in the different type wire holding portion 42a by having an exterior member 22a covering the outer periphery thereof gripped by the pair of holding claws 42d.

As shown in FIG. 4, the downward extending portion 42 includes downward extending inclined portions 42e widening the downward extending portion 42 toward the upper side Z1 when viewed in the first direction X1. The downward extending inclined portions 42e are provided on the pair of both side downward extending portions 42b. Further, the cover portion 46 in the open state includes a cover inclined portion 46b widening the cover portion 46 toward the lower side Z2 by being inclined along the downward extending inclined portion 42e while forming a gap between the downward extending inclined portion 42e and the cover inclined portion 46b when viewed in the first direction X1.

### Configuration of Resilient Piece 43

As shown in FIG. 2, the resilient piece 43 is provided to extend toward the lower side Z2 and extend in the first opposite direction X2 from below the fixing portions 41a.

In particular, as shown in FIG. 3, one resilient piece 43 is provided on the lower side Z2 between the two connectors 50. The resilient piece 43 is provided to extend toward the lower side Z2 and extend in the first opposite direction X2 from the lower end of the downward extending portion 42, in particular, the lower end of the coupling portion 42c.

Further, as shown in FIGS. 5 and 6, the resilient piece 43 is curved when viewed along the second axis Y. Further, the resilient piece 43 includes an arcuate protrusion 43a projecting toward the lower side Z2 on a tip when viewed along the second axis Y.

As shown in FIG. 6, the resilient piece 43 is provided to be able to be pressed into contact with the bottom wall 61 of the mounting member 60 to suppress the inclination of the protector body 41 with the fixing portions 41a as base points with the connectors 50 biased in the first opposite direction X2 by the mating connectors 70. In particular, the resilient piece 43 is so provided that the arcuate protrusion 43a presses and contacts the bottom wall 61 while being deflected toward the upper side Z1 with the fixing portions 41a fit in the fixing holes 63. For example, even in a state where the mating connector 70 constantly biases the connector 50, the resilient piece 43 presses and contacts the bottom wall 61, thereby functioning to hold on so that the protector body 41 is not inclined with the fixing portions 41a as a base point. Note that the mating connector 70 possibly constantly biases the connector 50 in the first opposite direction X2 by receiving forces from the wires (not shown) in a state connected to the mating connector 70 and deflected. Further, a length of the resilient piece 43 is so set that the resilient piece 43 projects further in the first opposite direction X2 than the protector body 41 while being pressed in contact with the bottom wall 61.

### Functions of Protector 30

Functions of the protector 30 configured as described above are described.

The two wire groups 20, 21 and the different type wire group 22 are held in the protector 30. The mating connectors 70 are first connected to the connectors 50 of the protector 30. The fixing portions 41 of the protector 30 are fit into the fixing holes 63 while the resilient piece 43 is so deflected that the arcuate protrusion 43a is pressed into contact with the bottom wall 61. In this state, the upper side Z1 of the protector 30 above the fixing portions 41a may be biased in the first opposite direction X2 by the connectors 50 being biased in the first opposite direction X2 by the mating connectors 70. In this case, the protector body 41 is inclined with the fixing portions 41a as base points due to the rattling of the fixing portions 41a and the fixing holes 63 or the like, but that inclination is suppressed by the resilient piece 43 pressed in contact with the bottom wall 61.

### Effects of Embodiment

Next, effects of the above embodiment are described below.
(1) The upper side Z1 of the protector 30 above the fixing portions 41a may be biased in the first opposite direction X2 by the connectors 50 being biased in the first opposite direction X2 by the mating connectors 70. However, since the resilient piece 43 of the protector 30 provided to extend toward the lower side Z2 and extend in the first opposite direction X2 from below the fixing portions 41a is pressed into contact with the bottom wall 61 of the mounting member 60, inclination with the fixing portions 41a as base points is suppressed. Further, since the resilient piece 43 is provided to extend toward the lower side Z2 and extend in the first opposite direction X2, the resilient piece 43 is satisfactorily pressed in contact with the bottom wall 61 even if distances from the fixing portions 41a to the bottom wall 61 are subtly different due to a manufacturing error of the mounting member 60 or the like. Thus, the inclination of the protector 30 with the fixing portions 41a as base points is stably suppressed. Specifically, even if a part on the upper side Z1 of the protector 30 above the fixing portions 41a is biased in the first opposite direction X2, the resilient piece 43 holds on, thereby preventing the inclination of the protector 30 with the fixing portions 41a as base points or an angle of inclination of the protector 30 is reduced. Therefore, for example, the contact of the protector 30 with other members is suppressed.
(2) The length of the resilient piece 43 is so set that the resilient piece 43 projects further in the first opposite direction X2 than the protector body 41 while being pressed in contact with the bottom wall 61. Thus, even if the distances from the fixing portions 41a to the bottom wall 61 are largely different due to the manufacturing error of the mounting member 60 or the like, the resilient piece 43 is satisfactorily pressed into contact with the bottom wall 61. Therefore, the inclination of the protector 30 with the fixing portions 41a as base points is more stably suppressed.
(3) Since one resilient piece 43 is provided on the lower side Z2 between the two connectors 50 to be biased by the mating connectors 70, the inclination of the protector 30 with the fixing portions 41a as base points can be suppressed in a well-balanced manner by one resilient piece 43.
(4) The downward extending portion 42 extending toward the lower side Z2 is provided on the lower side Z2 of the protector body 41 between the two connectors 50, and the resilient piece 43 is provided to extend toward the lower side Z2 and extend in the first opposite direction X2 from the lower end of the downward extending portion 42. Thus, a position where the resilient piece 43 is pressed in contact with the bottom wall 61 can be set far from the fixing portions 41a, for example, as compared to the case where the resilient piece 43 extends from the lower end of the protector body 41 without providing the downward extending portion 42. Therefore, the inclination of the protector 30 with the fixing portions 41a as base points can be more suppressed.
(5) Since the protector body 41 includes the body portion 45 provided with the opening 44 open in the first opposite direction X2 and configured to accommodate the wire groups 20, 21 inside and the cover portions 46 for closing the opening 44, the protrusion of the wire groups 20, 21 from the protector body 41 is prevented. Further, since the cover portions 46 are coupled to the lower end of the body portion 45 rotatably from the open state to the closed state by the thin hinge portions 47 at the positions corresponding to the connectors 50, the cover portions 46 can be integrally molded to the body portion 45. Further, since the downward extending portion 42 includes the downward extending inclined portions 42e widening the downward extending portion 42 toward the upper side Z1 when viewed in the first direction X1, it can be suppressed that the downward extending portion 42 is bent from an upper end even if the resilient piece 43 is pressed into contact with the bottom wall 61. Thus, the inclination of the protector 30 with the fixing portions 41a as base points can be stably suppressed. Further, the cover portion 46 in the open state includes the cover inclined portion 46b widening the cover portion 46 toward the lower side Z2 by being inclined along the downward extending inclined portion 42e while forming the gap between the downward extending inclined portion 42e and the cover inclined portion 46b. Therefore, a range where the cover portion 46 covers the opening 44 can be made wider while the integral molding of the cover portion 46 and the downward extending portion 42 is facilitated.
(6) Since the downward extending portion 42 includes the different type wire holding portion 42a capable of holding the different type wire group 22, the different type wire group 22 can be held.
(7) The downward extending portion 42 includes the different type wire holding portion 42a, the pair of both side downward extending portions 42b extending toward the lower side Z2 from the protector body 41 on the both sides of the different type wire holding portion 42a while being separated from the different type wire holding portion 42a, and the coupling portion 42c coupling the tips of the pair of both side downward extending portions 42b. The resilient piece 43 extends from the lower end of the coupling portion 42c. In this configuration, the coupling portion 42c and the pair of both side downward extending portions 42b where the resilient piece 43 is provided are configured to hardly receive a force from the different type wire holding portion 42a by being separated from the different type wire holding portion 42a. Thus, for example, even if a force is applied to the different type wire holding portion 42a from the different type wire group 22, it is suppressed that functions of the resilient piece 43 are impaired.

### Modifications

The above embodiment can be modified and carried out as follows. The above embodiment and the following modifications can be combined with each other and carried out without technically contradicting.
Although the length of the resilient piece 43 is so set that the resilient piece 43 projects further in the first opposite direction X2 than the protector body 41 while being pressed in contact with the bottom wall 61 in the above embodiment, there is no limitation to this.

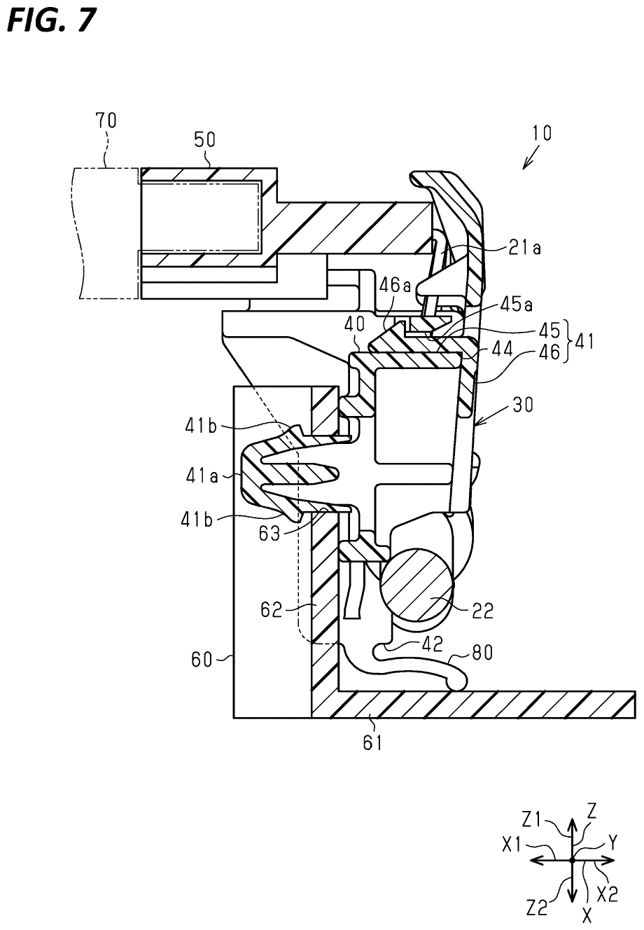

For example, as shown in FIG. 7, a length of a resilient piece 80 may be so set that the resilient piece 80 does not project in the first opposite direction X2 from the protector body 41 while being pressed in contact with the bottom wall 61. By doing so, the enlargement of an arrangement space for the protector 30 when viewed from the upper side Z1 can be, for example, prevented.
Although the protector 30 is provided with two connectors 50 in the above embodiment, there is no limitation to this. For example, the configuration of the protector 30 may be changed to the one provided with only one connector 50 or to the one provided with three or more connectors 50. Further, the number of the wire groups 20, 21 to be held by the protector 30 may be changed according to the number of the connectors 50.
Although one resilient piece 43 is provided on the lower side Z2 between the two connectors 50 in the above embodiment, there is no limitation to this. For example, the resilient piece 43 may be provided on the lower side Z2 of each of the two connectors 50.
Although the downward extending portion 42 extending toward the lower side Z2 is provided on the lower side Z2 of the protector body 41 between the two connectors 50 and the resilient piece 43 extends from the lower end of the downward extending portion 42 in the above embodiment, there is no limitation to this. For example, the downward extending portion 42 may not be provided and the resilient piece 43 may extend from the lower end of the protector body 41.
Although the cover portions 46 are coupled to the lower end of the body portion 45 rotatably from the open state to the closed state by the thin hinge portions 47 in the above embodiment, there is no limitation to this. For example, the cover portions 46 may be separate from the body portion 45.
Although the downward extending portion 42 includes the downward extending inclined portions 42e widening the downward extending portion 42 toward the upper side Z1 when viewed in the first direction X1 in the above embodiment, there is no limitation to this and the downward extending inclined portions 42e may not be provided. Further, although the cover portion 46 includes the cover inclined portion 46b, there is no limitation to this and the cover inclined portion 46b may not be provided.
Although the downward extending portion 42 includes the different type wire holding portion 42a capable of holding the different type wire group 22 in the above embodiment, there is no limitation to this and the different type wire holding portion 42a may not be provided.
Although the downward extending portion 42 includes the different type wire holding portion 42a, the pair of both side downward extending portions 42b provided away from the different type wire holding portion 42a and the coupling portion 42c in the above embodiment, there is no limitation to this. For example, the coupling portion 42c and the pair of both side downward extending portions 42b may be connected to the different type wire holding portion 42a.
Although the fixing portions 41a are provided at two positions corresponding to the connectors 50 in the above embodiment, there is no limitation to this. For example, the configuration may be changed to the one provided with only one fixing portion 41a or to the one provided with three or more fixing portions 41a.
The resilient piece 43 of the above embodiment may have a shape different from the shown shape if the resilient piece 43 is provided to extend toward the lower side Z2 and extend in the first opposite direction X2 and shaped to similarly function. For example, the resilient piece 43 may be shaped not to include the arcuate protrusion 43a. Further, for example, the resilient piece 43 may not have a curved shape.
The embodiment disclosed this time is illustrative in all aspects, and the present invention is not limited to these illustrations. That is, the scope of the present invention is represented by claims and intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A protector, comprising:
a protector body including a fixing portion to be fixed to a side wall of a mounting member along a first direction intersecting the side wall, the protector body holding a wire group;
a connector provided above the fixing portion, a mating connector being connected to the connector from the first direction; and
a resilient piece provided to extend downward and extend in a first opposite direction opposite to the first direction from below the fixing portion, the resilient piece being able to be pressed into contact with a bottom wall of the mounting member to suppress inclination of the protector body with the fixing portion as a base point with the connector biased in the first opposite direction by the mating connector.

2. The protector of claim 1, wherein a length of the resilient piece is so set that the resilient piece projects further in the first opposite direction than the protector body while being pressed in contact with the bottom wall.

3. The protector of claim 1, wherein:
two connectors are provided, and
one resilient piece is provided below and between the two connectors.

4. The protector of claim 3, wherein:
a downward extending portion extending downward is provided on a lower side of the protector body between the two connectors, and
the resilient piece is provided to extend downward and extend in the first opposite direction from a lower end of the downward extending portion.

5. The protector of claim 4, wherein:
the protector body includes a body portion provided with an opening open in the first opposite direction and configured to accommodate the wire group inside and a cover portion coupled to a lower end of the body portion rotatably from an open state to a closed state by a thin hinge portion at a position corresponding to the connector and configured to close the opening in the closed state,
the downward extending portion includes a downward extending inclined portion widening the downward extending portion toward an upper side when viewed in the first direction, and
the cover portion in the open state includes a cover inclined portion widening the cover portion toward a lower side by being inclined along the downward extending inclined portion while forming a gap between the downward extending inclined portion and the cover inclined portion when viewed in the first direction.

6. The protector of claim 4, wherein the downward extending portion includes a different type wire holding portion capable of holding a different type wire group.

7. The protector of claim 6, wherein:
the downward extending portion includes the different type wire holding portion provided to extend downward from the protector body, a pair of both side downward extending portions extending downward from the protector body on both sides of the different type wire holding portion while being separated from the different type wire holding portion, and a coupling portion coupling tips of the pair of both side downward extending portions, and
the resilient piece is provided to extend downward and extend in the first opposite direction from a lower end of the coupling portion.

8. The protector of claim 1, wherein a length of the resilient piece is so set that the resilient piece does not project in the first opposite direction from the protector body while being pressed in contact with the bottom wall.
